(19) United States
(12) Patent Application Publication
(10) Pub. No.: US 2008/0233471 A1
(43) Pub. Date: Sep. 25, 2008

(54) Battery State Detection

(76) Inventors: Richard Aumayer, Diekholzen (DE); Burkhard Iske, Weil Der Stadt (DE)

Correspondence Address: KENYON & KENYON LLP, ONE BROADWAY, NEW YORK, NY, 10004, US

(21) Appl. No.: 11/579,893

(22) PCT Filed: May 13, 2005
(86) PCT No.: PCT/EP05/52202

§ 371 Date: May 13, 2008

(30) Foreign Application Priority Data
May 13, 2004 (DE) 10 2004 023 543.0
May 4, 2005 (DE) 10 2005 020 835.5

(51) Int. Cl. H01M 10/48; G08B 21/00

(52) U.S. Cl. 429/92; 340/636.15

(57) ABSTRACT

A battery state detection arrangement is provided for use in conjunction with a series connection of multiple battery cells, e.g., a series connection of at least two lead batteries in a vehicle electric system having a voltage which is higher than conventional system voltages. The battery state detection arrangement detects both a defect in a battery and a defect in the overall system and transmits signals to a higher-level energy management system as well as, if necessary, a display. Additional components provide a charge equalization in the batteries by selectively recharging or selectively discharging unevenly charged batteries.

### FIELD OF THE INVENTION

The present invention relates to battery state detection, in particular a battery state detection device having multiple series-connected batteries, battery cells or other charge and/or energy accumulators.

### BACKGROUND INFORMATION

Batteries, for example those used in motor vehicles, usually include multiple battery cells connected in series. The nominal voltage of the batteries is derived from the sum of the individual voltages of the battery cells. The batteries themselves have two connections, a positive and a negative connection, between which lies their nominal voltage. Because a single battery may not be sufficient to generate the desired voltage, it is also known to connect at least two batteries in series and thereby obtain a voltage equal to the sum of the nominal voltages of the batteries. This type of series connection of two 12-volt batteries is common, for example in commercial vehicles, to achieve an overall voltage of 24 volts. Consumers which require a 12-volt supply voltage are connectable to either of the two batteries; consumers which require a higher voltage are connected to the terminals of the series connection of the two batteries.

Since the series-connected battery cells, or the series-connected batteries, may discharge at different rates, the use of switching means is provided, for example, as described in published German patent document 101 50 376, these means equalizing the charge between the batteries during both battery charging and discharging. This is intended to ensure that both batteries are charged evenly. The switching means which provide the charge equalization function are relatively complex and include at least one capacitor as well as multiple transistors and a corresponding logic. However, a battery state detection is not provided by the prior art.

In the case of power supply devices, for example in a vehicle electric system having only one battery, the implementation of a battery state detection is known. For example, published German patent document 101 06 505 discloses a method for detecting the instantaneous battery state via a measured operating parameter of the battery as well as a state estimation routine, thereby preventing, in particular, complete discharging of the battery.

### SUMMARY

The state detection according to the present invention in the case of a charge accumulator, e.g., a battery state detection, has the advantage that it enables a reliable state detection when multiple battery cells are connected in series, e.g., when multiple charge accumulators, multiple batteries or multiple battery cells are connected in series. It is particularly advantageous that a state detection, e.g., a battery state detection based on a battery state detection for a 12 V battery, may be used, in particular, for a 24 V power supply having two series-connected 12 V batteries.

Additional measures according to the present invention relate to ways to obtain voltages, as in the case of systems having higher voltage levels in which a number of individual cells to be monitored are referred to as clusters, by series-connecting multiple clusters which represent an integral multiple of the individual cell voltages, thereby achieving a battery state detection for each cluster as well as for the overall system. The battery state detection functions are computer-supported and take into account presettable algorithms. To reduce computing power when evaluating large clusters, it may be advantageous to allow simplifications and assume, in the case of clusters including individual cells having the same physical properties, that these physical properties change in the same manner.

To detect the battery state, the battery voltage and the battery temperature, which are ascertained separately for each battery, as well as the measured current flowing through the series-connected batteries, are evaluated in the evaluation apparatus, for example a control unit. A battery state algorithm is thus calculated for each battery, independently of the overall system, enabling detection of the state of each of the two batteries. Based on this information, a statement may be made about the individual batteries or energy accumulators and/or the overall system.

Further measures according to the present invention relate to the ability to selectively recharge one battery cell, one battery or both batteries or a cluster, provided that the battery state detection indicates a different charge state for a battery.

It is particularly advantageous that the consequences of uneven discharging as well as different aging effects of the individual battery cells, in particular the individual batteries, are detected, thereby reliably preventing a reduction in the efficiency of the overall system. The detection of uneven discharging as well as different aging effects is enabled by assigning a separate battery state detection to each battery cell, in particular to each battery, and by associating the results of the battery state detections carried out for the individual batteries via a higher-level battery state detection.

If an uneven battery state is detected, selective measures may be advantageously initiated to enable selective recharging of the battery having the poorer charge state and thus more efficient use of the overall system. According to an advantageous example embodiment, a DC/DC converter may be provided to increase the charge voltage for the more poorly charged battery in a presettable manner, thereby achieving a better charge. All battery cells or both batteries may thereby be maintained at the same charge level and thus be optimally charged.

If an unequal state of the charge accumulator or batteries is detected, selective measures may be advantageously initiated to enable a selective discharging of the charge accumulator or battery having the better charge state. All battery cells or both batteries may thereby be maintained at the same charge level and thus be optimally charged. This also enables the overall system to be used more efficiently, since it prevents the battery having the better charge from determining the current and reverse voltage during charging and thus the battery having the poorer charge from being insufficiently charged. In a particularly advantageous example embodiment, the selective discharging of the battery having the better charge state, which is provided selectively for equalizing the charge, is carried out by an additional resistor which is connectable via a changeover switch to the battery having the better charge state.

In another advantageous example embodiment, the control unit itself may be used to discharge the battery having the better charge.

If a separate control unit is assigned to each battery, the hardware of conventional systems, i.e., 12-volt systems, may be advantageously transferred at little cost, thereby obtaining a highly cost-effective arrangement.

The battery state detection according to the present invention advantageously works together with a typically computer-supported electric energy management system (EEM) in a vehicle, the latter accessing the information of the battery state detection and initiating the necessary activation functions. Display means may be used to display the present battery states.

The battery state detection according to the present invention may be used, with modifications, not only for batteries, but also generally for all charge accumulators, and may also be advantageously used for combinations of different types of charge accumulators.

### BRIEF DESCRIPTION OF THE DRAWINGS

FIG. 1 shows a schematic illustration of a battery state detection for a series connection of energy accumulators, for example a series connection of two lead batteries in a 24 V electric system of a vehicle.

FIG. 2 shows a schematic illustration of a battery state detection for a series connection of clusters of energy accumulators.

FIG. 3 shows a schematic illustration of a battery state detection having selective recharging, for example for two lead batteries in a 24 V vehicle electric system.

FIG. 4 shows a schematic illustration of a battery state detection having selective discharging, for example also for two lead batteries in a 24 V vehicle electric system.

FIG. 5 shows a schematic illustration of a further exemplary embodiment for selective discharging of the battery having the better charge, using control units.

FIG. 6 shows a schematic illustration of an exemplary embodiment of a battery management system for any voltage and system.

### DETAILED DESCRIPTION

Battery state detection devices for 12 V batteries work, for example, in such a way that the battery state is ascertained from different measured battery variables. These variables may be the battery current, battery voltage and battery temperature. The battery state is determined on the basis of these variables in an evaluation apparatus, for example a control unit.

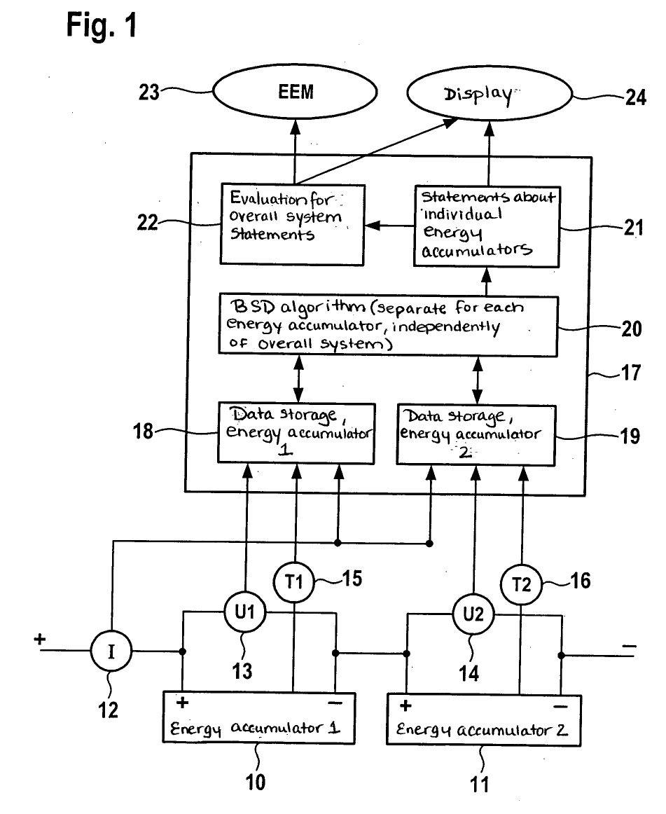

FIG. 1 shows a battery state detection to be used to detect the battery state in a system including two series-connected batteries. If two energy accumulators or batteries 10, 11 are connected in series, it is sufficient to use a current sensor 12 to ascertain overall current I, while the parameters of temperature T and voltage U as well as the variations thereof must be detected separately for each energy accumulator or each battery. For example, voltmeters 13, 14, which ascertain voltages U1 and U2, respectively, as well as temperature sensors 15, 16, which ascertain temperatures T1 and T2, respectively, are used for this purpose. The corresponding measured values are supplied to and evaluated by battery state detector 17.

Battery state detector 17 is, for example, a control unit including a processor or microcomputer (not illustrated) and also includes at least two memories 18, 19 for storing the data of energy accumulator 1 or battery 10 as well as energy accumulator 2 or battery 11. Evaluation means 20 are also provided for processing a battery state algorithm, this taking place separately for each energy accumulator or each battery 10, 11, independently of the overall system.

The result of this evaluation is supplied to a block 21, which provides a statement about the state of the individual energy accumulators to a block 22. The overall system statements are evaluated in block 22, taking into account the statements made in block 21 about the individual energy accumulators or batteries 10, 11. Depending on the result of the evaluation of the overall system statements in block 22, a notification is provided to electric energy management system (EEM) 23 and, if necessary, a display 24 is initiated, it also being possible to initiate display 24 alone if the statements about a single energy accumulator require such a display.

Using the system described in FIG. 1 for a battery state detection in a series connection of energy accumulators, for example two lead batteries in a 24 V vehicle electric system, an overall evaluation of the system may be derived from the individual statements for each battery. The evaluation of the overall system may be used both in a display and in an energy management system. Transferring the battery state detection known for 12 V batteries to a series connection of energy accumulators makes it possible to use existing know-how. It is possible to monitor the individual batteries and, if necessary, also carry out selective equalization charging on only one battery or only one energy accumulator if an SOC (state-of-charge) difference occurs. Battery state detector 17, or the microcomputer of the control unit involved, may be equipped with a single processor having a high clock frequency, the processor performing the evaluation consecutively for the individual batteries. Subsequently connecting a 12 V consumer to one battery enables premature system failures to be avoided, since the battery state detection described above detects a connection of this type, and selective recharging of the battery concerned may be carried out or other suitable measures may be taken.

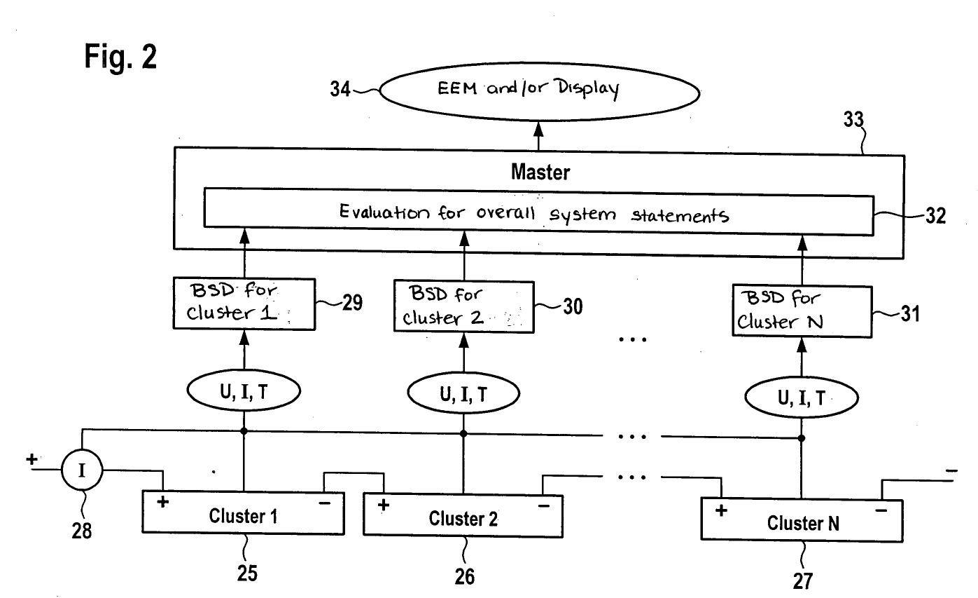

FIG. 2 shows a battery state detection for a series connection of multiple clusters of energy accumulators. A number of individual cells to be monitored is referred to as a cluster. Series-connecting a plurality of clusters of this type enables voltages to be achieved which represent an integral multiple of the individual cell voltages or individual clusters. In this case as well, a single current measurement which yields the overall current of the series connection of the clusters is sufficient to carry out an effective and efficient battery state detection. However, parameter voltage U and temperature T should be detected for each cluster to enable reliable evaluation. The individual cells or clusters may also include electrochemical systems other than lead acid cells. In this case, the evaluation algorithms must be adapted accordingly.

The evaluation algorithms may require a great deal of computing power, so that a cluster monitored by a single arithmetic unit should not be any desired size. In the case of clusters of individual cells having the same physical properties, it may be assumed that their physical variables change in approximately the same manner. This is true, in particular, for aging, internal resistance, state of charge (SOC), etc. By monitoring a subset of individual cells, it is therefore possible to determine the state of the remaining individual cells. Varying this subset regularly makes it possible to monitor the entire cluster within a shorter processing time.

The battery state detection illustrated in FIG. 2 for a series connection of clusters of energy accumulators or batteries has the following layout:

The individual battery cells, which are designated as cluster 1, cluster 2 through cluster N, are identified by reference numerals 25, 26 and 27 and are series-connected to each other, the positive pole of one cluster being connected in the usual manner to the negative pole of the other cluster. A current measurement 28 supplies overall current I. In addition, voltage U and temperature T are ascertained for each cluster or each number of individual cells, using sensors or voltmeters (not illustrated). The variables of voltage U, current I and temperature T are supplied to separate battery state detection units for individual cluster 1, cluster 2 . . . cluster N. The associated battery state detection units are identified by reference numerals 29, 30 and 31. The results of the individual battery state detections for cluster 1, cluster 2, cluster N are supplied to a block 32 for evaluation for overall system statements. The evaluation for overall system statements is, for example, part of a master 33, which emits an output signal to electric energy management system EEM and/or to a display 34.

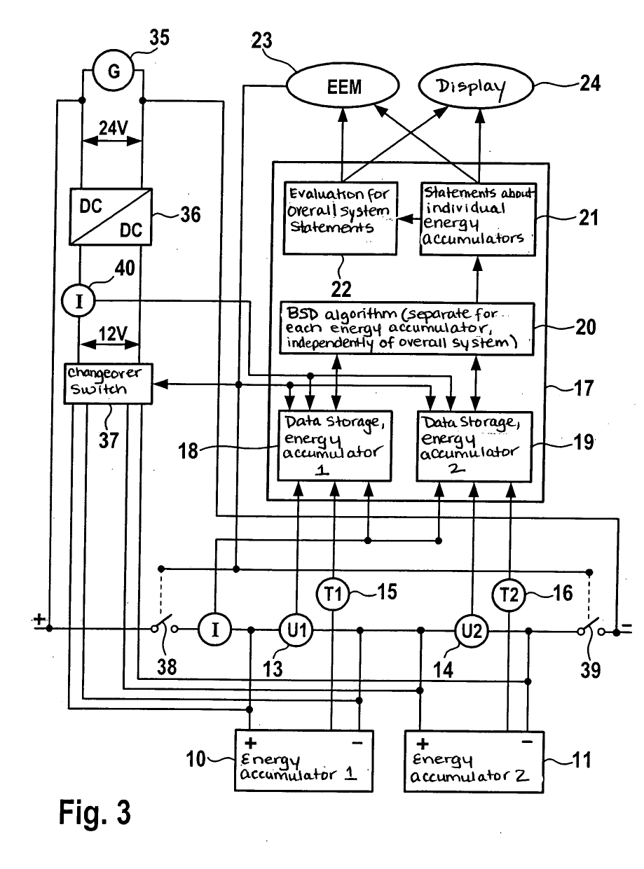

FIG. 3 shows a battery state detection which provides selective recharging of one of the energy accumulators or one of the batteries. The actual battery state detection is identical to the battery state detection known from FIG. 1. In addition, switching means are also provided, which may be used to selectively recharge the battery having the poorer charge state.

These means include generator 35, which is designed as a 24 V generator and may be used to selectively recharge one of the batteries via a voltage transformer 36 and a changeover switch 37. The series connection of the two energy accumulators 10, 11 is connectable to the positive connection of the system via additional switching elements 38, 39. Management of the selective recharging of one of the two batteries is handled by electric energy management system EEM, which is connected to changeover switch 37 as well as switches 38, 39 via corresponding connections and also opens and closes them. The 24 V voltage supplied by generator 35 is converted by DC/DC converter 36 to 12 V and supplied to battery 10 or 11 to be charged via changeover switch 37. To provide electric isolation between the generator and battery to be recharged, battery 10 or 11 is decoupled from the remaining vehicle electric system, so that generator 35 must handle the supply for the entire electric system for the duration of the selective recharging. Alternatively, this isolation may also be achieved by a suitable design of the DC/DC converter.

Charge current IL for selective recharging is detected by a further current sensor 40 and supplied to accumulators 18, 19, thus making battery state detector 17 available for state detection. Unequal discharging as well as various aging effects of the individual batteries, which might reduce the performance of the overall system, are thus detected and may thereby be avoided. The battery state detection of the individual 12 V batteries is the basis for determining the need for selective recharging of the individual batteries and thus a more efficient use of the overall system.

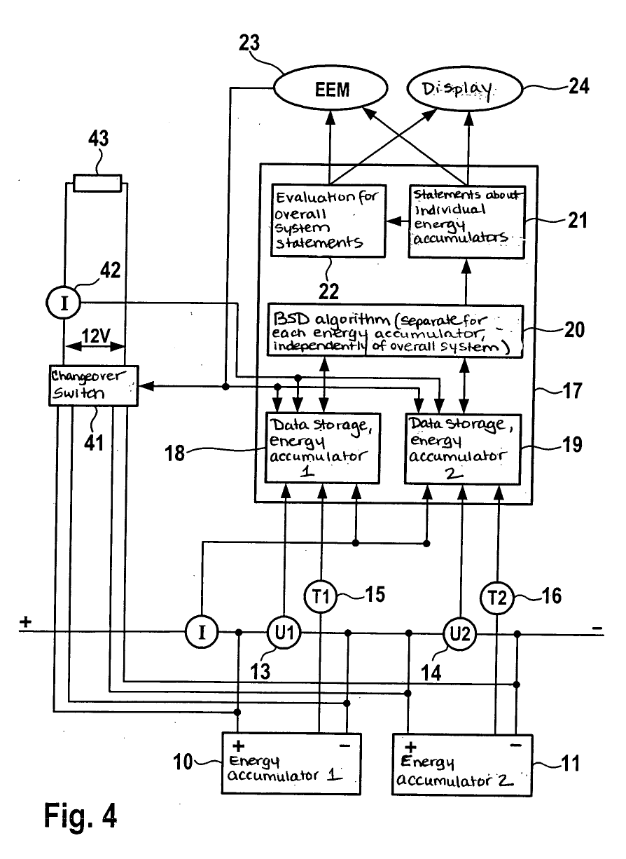

FIG. 4 shows another exemplary embodiment of a battery state detection, including a system having two energy accumulators or batteries 10, 11, for example two lead batteries in a 24 V vehicle electric system. In the case of this exemplary embodiment, the battery state detection takes place in the same manner as in the exemplary embodiment according to FIG. 1. In addition, selective discharging is used to ensure that both energy accumulators and batteries are charged evenly. For this purpose, the battery for which the battery state detection shows the higher charge state is discharged selectively until its state equals the state of the other battery.

Specifically, the battery state detection according to FIG. 1 is supplemented by a changeover switch 41 which is set to 12 V as well as a current meter 42 which measures current IE, and a resistor 43 including a corresponding circuit. These components enable selective discharging of an individual battery. Management of the selective discharging is handled by electric energy management system (EEM) 23. The battery having the better, i.e., higher, charge state is discharged in a defined manner via resistor 43. The connection to the resistor is established by changeover switch 41, which is activated by EEM 23. The discharge current for selective discharging is detected by further current sensor 42 and provided to the corresponding battery state detector. The method is especially suitable when minor differences in the charge state are to be equalized.

In a further example embodiment excluding an additional current measurement, the application of an additional resistor to each battery via the changeover switch may be provided. In this case, the changeover switch receives the information about the uneven charge state and connects the additional resistor. The period of time during which the additional resistor is to be connected is calculated by electric energy management system 23, for example via the known difference in charge states and the known value of the additional resistor. This procedure enables the charge state to be equalized so that a difference in charge states no longer exists.

In a further variant for selective discharging of a battery, the control unit itself may be used. For this purpose, the control unit power supply must be connected to the battery to be discharged via a corresponding changeover switch. The control unit is able to continuously measure the discharge current even during idle phases without burdening the remaining batteries. In addition, the discharge current is settable separately for each battery within certain parameters by varying the clock frequency of the arithmetic unit of the control unit.

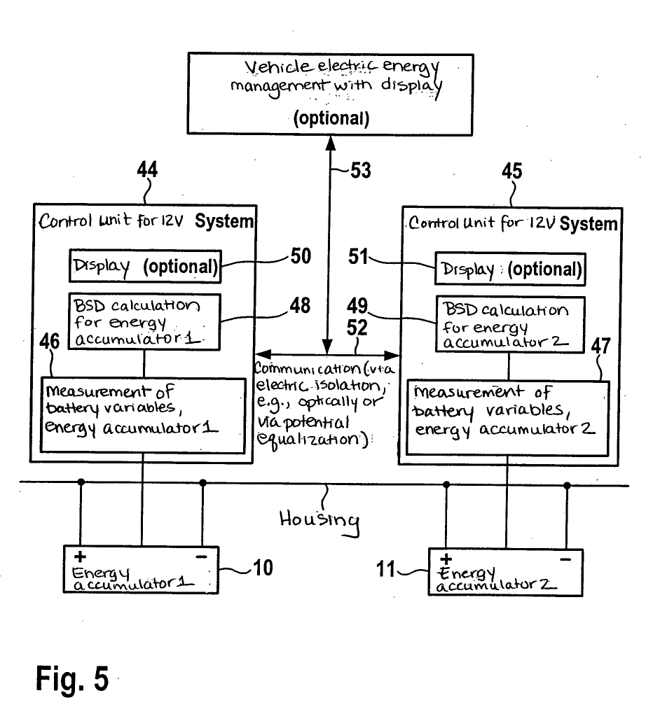

FIG. 5 shows a further exemplary embodiment of the present invention as an extension of the aforementioned arrangement, in which the control unit itself is used for selective discharging of the battery. In this case, a separate control unit is used for each battery, and, as described above, the control unit itself is therefore able to discharge the battery in that the control unit handles the switching function, or the current consumption of the control unit is increased, for example, by clocking the control unit processor accordingly. This measure makes it possible to eliminate the changeover switch, which is needed for electric isolation and is quite complex.

If the control unit is equipped with a current sensor, the discharge current may also be measured precisely. In this embodiment, multiple batteries may also be discharged simultaneously and independently of each other, each control unit determining the discharge current and discharge duration for one battery.

Specifically, FIG. 5 shows the two energy accumulators or batteries 10 and 11, each of which is connected to one control unit 44 and 45 via corresponding connections, the exact interconnection not being illustrated, but may correspond to the arrangement in FIG. 1, for example. Each control unit includes means 46 and 47 for measuring the battery variables, for example voltage U, current I and temperature T of the battery concerned. Means for battery state detection (BSD) 48, 49 are also provided, as are displays 50, 51 (optional). The control units are connected to each other via a communication connection 52, and an electric energy management system of the vehicle (including display) may also be integrated via a further connection 53.

Two different example embodiments may be implemented based on a central or decentralized approach. In the case of the central approach, each control unit determines the state of one battery and forwards the information to a higher-level energy management system. The latter determines which battery is to be discharged and displays additional information to the user via display means.

According to the decentralized approach, each control unit receives the information about the states of the other batteries via a communication connection which electrically isolates the control units or provides a potential adjustment. Each control unit then determines whether the battery is to be discharged, taking into account the information about the states of the remaining batteries, either automatically or interactively with the other control units. Each control unit may also be equipped with a display, for example an LED which shows the charge state of the battery and, for example, indicates that a battery needs to be replaced. A decentralized approach of this type may be used as an upgrade kit, since it does not require communication with the rest of the vehicle, and the system operates with full autonomy.

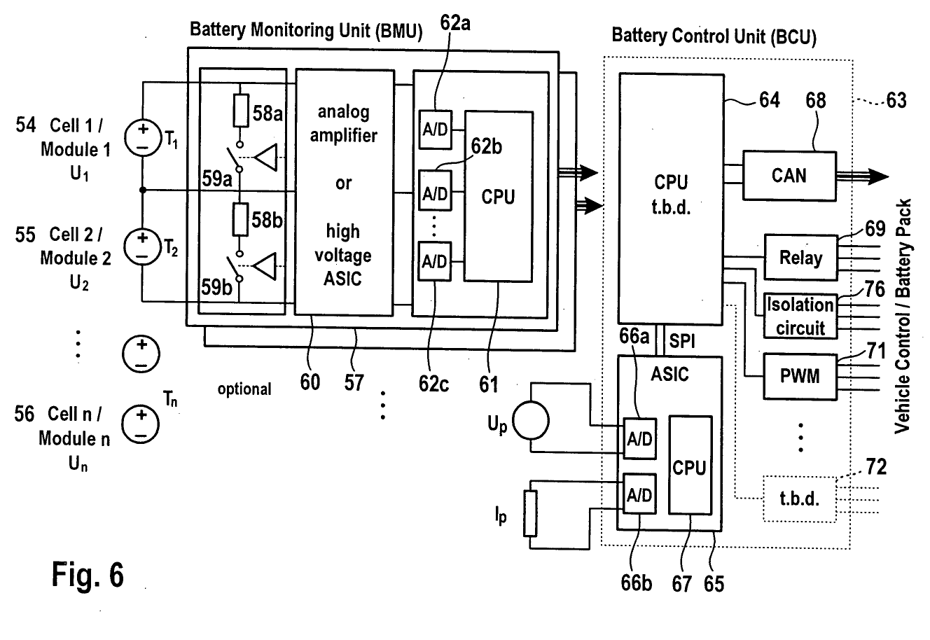

FIG. 6 shows an exemplary embodiment of the present invention which is designed for any voltage and system and is suitable for using scalable and standardizable control unit families. An exemplary embodiment of this type is especially suitable as an electric energy management system or a battery manager in connection with commercial vehicles having a plurality of n battery modules 54 through 56. Temperatures T1 through Tn (optional) thereof are measured by suitable sensors and supplied to battery state display 57 or multiple battery state displays of this type. Battery state display 57 includes an input circuit 58a, 58b, each having one switch 59a, 59b, an analog amplifier or a high-voltage ASIC 60 as well as a CPU 61, which is connected to the ASIC via A/D converters 62a, 62b, 62c.

Control unit 63 of the electric energy management system (battery control unit (BCU)) includes at least one CPU 64, which is connected to an ASIC 65 via an interface, for example an SPI interface. The CPU is freely selectable and may be used, in particular, to maintain a scalable and standardized control unit family. With suitable adjustments, the overall system may therefore be designed to be used for any voltage.

Voltage Up and current Ip are supplied to ASIC 65 via A/D converters. These variables, which are characteristic for the battery pack, represent the overall current or overall voltage and are processed by a separate CPU 67. The evaluation results are provided to the BMU via the SPI interface, and the BMU takes these results into account when ascertaining the battery state. The ascertained battery state is then forwarded from the BMU to control unit 63.

Via a suitable interface, for example a CAN interface 68 as well as blocks 69 through 72, CPU 64 of battery control unit 63 is connected to the relay, an isolation circuit, a pulse width modulation circuit and corresponding circuits or devices, if necessary via selectable arrangements.

The exemplary embodiments described above may be suitable for expanding conventional battery state detection systems for 12 V batteries to power supply systems in which at least two 12 V batteries are connected in series, thereby obtaining an overall voltage of 24 volts. This enables the battery state detection according to the present invention to also be used in the electric systems of commercial vehicles having the usual 24 volt system voltage. In principle, however, the present invention may also be used for a series connection of multiple battery cells, each of which forms a cluster, the charge state of each cluster being ascertainable either individually or as a whole. The term “battery” represents any charge or energy accumulator and thus also covers, for example, lead acid batteries, battery cells, clusters of charge accumulators, nickel-cadmium cells and capacitors, etc.

1-23. (canceled)

24. A device for detecting a state of an energy accumulator, comprising:
a detection unit for detecting selected parameters of the energy accumulator; and
an evaluation unit for ascertaining the state of the energy accumulator from the selected parameters detected;
wherein the energy accumulator includes at least two series-connected cells, and wherein the selected parameters include at least one of voltage and temperature of the at least two series-connected cells, and wherein overall current of the at least two series-connected cells is measured.

25. The device as recited in claim 24, wherein the energy accumulator is part of a vehicle electric system and includes at least two series-connected battery cells.

26. The device as recited in claim 25, wherein the energy accumulator includes two series-connected lead batteries for generating an overall voltage of 24 V.

27. The device as recited in claim 24, wherein the energy accumulator is a battery, and wherein the battery includes a series connection of clusters of component energy accumulators, each clusters including a predetermined number of individual cells, whereby an overall battery voltage is achieved which is an integral multiple of an individual cell voltage.

28. The device as recited in claim 27, wherein at least one of voltage and temperature is ascertained for one of a) the battery and b) each cluster, and wherein a separate battery state detection unit is assigned to each cluster.

29. The device as recited in claim 27, further comprising:
an evaluation apparatus which is connected to the individual battery state detection units, wherein the evaluation apparatus transmits signals to at least one of a higher-level energy management system and a display, depending on information obtained from the individual battery state detection units.

30. The device as recited in claim 29, wherein the evaluation apparatus includes a processor which, using a predetermined evaluation algorithm, ascertains an overall state of the battery based on information obtained from the individual battery state detection units, and wherein the processor ascertains the state of each individual cluster separately.

31. The device as recited in claim 30, wherein, in determining the overall state of the battery, clusters of individual cells having the same physical properties are combined, and wherein the predetermined evaluation algorithm takes into the account the fact that physical variables of the individual cells change in substantially the same manner over time.

32. The device as recited in claim 30, further comprising:
a charge adjustment arrangement which enables the charge to be adjusted in the individual clusters.

33. The device as recited in claim 32, wherein the charge adjustment arrangement enables a selected cluster to be selectively charged, and wherein the selected cluster has a lower charge state in comparison to another cluster.

34. The device as recited in claim 33, wherein the charge adjustment arrangement includes at least one generator, a voltage transformer, and change-over switches which are activated in such a way that the selected cluster to be selectively charged is temporarily connected to the voltage transformer and the another cluster is simultaneously disconnected from the voltage transformer.

35. The device as recited in claim 34, wherein the charge adjustment arrangement includes a current meter which measures a charge current, and wherein the charge adjustment arrangement takes into account the measured charge current when ascertaining the battery state.

36. The device as recited in claim 32, wherein the charge adjustment arrangement enables a selected cluster to be selectively discharged, and wherein the selected cluster has a higher charge state in comparison to another cluster.

37. The device as recited in claim 36, wherein the charge adjustment arrangement includes at least one discharging resistor and change-over switches which are activated in such a way that the selected cluster to be selectively discharged is temporarily connected to the discharging resistor and the another cluster is simultaneously disconnected from the discharging resistor.

38. The device as recited in claim 36, wherein the selective discharging of the selected cluster takes place via a control unit for the battery, wherein the control unit is selectively connected to the selected cluster to be discharged via a change-over switch.

39. The device as recited in claim 36, wherein each cluster is assigned a control unit, and wherein the selective discharging takes place via the control unit assigned to the selected cluster to be discharged, the control unit assigned to the selected cluster increasing a current consumption by the control unit.

40. The device as recited in claim 39, wherein multiple clusters are discharged simultaneously by activating the corresponding assigned control units.

41. The device as recited in claim 38, wherein a current meter is provided which measures a discharge current, and wherein the measured discharge current is taken into account in ascertaining the battery state.

42. The device as recited in claim 41, wherein the ascertaining of the battery state is carried out centrally by each control unit, and wherein the ascertained battery state information is supplied to the higher-level energy management system, and wherein the higher-level energy management system determines, using the ascertained battery state information, which battery is to be discharged.

43. The device as recited in claim 41, wherein the ascertaining of the battery state is carried out by the higher-level energy management system, and wherein the higher-level energy management system supplies the individual control units with the ascertained battery state information via a communication connection, and wherein each control unit determines in a decentralized manner, using the ascertained battery state information, which battery is to be discharged.

44. The device as recited in claim 33, wherein the charge adjustment arrangement terminates charge adjustment when a predetermined equalization state is detected.

45. The device as recited in claim 34, wherein the charge adjustment arrangement terminates charge adjustment when a predetermined equalization state is detected.

46. A method for detecting a state of an energy accumulator, comprising:
detecting selected parameters of the energy accumulator; and
ascertaining the state of the energy accumulator from the selected parameters detected;
wherein the energy accumulator includes at least two series-connected cells, and wherein the selected parameters include at least one of voltage and temperature of the at least two series-connected cells, and wherein overall current of the at least two series-connected cells is measured.
